(19) United States
(12) Patent Application Publication
(10) Pub. No.: US 2012/0223631 A1
(43) Pub. Date: Sep. 6, 2012

(54) EMITTING APPARATUS FOR WASHING LIGHT NANOIMPRINT TEMPLATE AND METHOD FOR THE SAME

(75) Inventors: Keita Yoshihara, Hyogo (JP); Masatoshi Shimonaka, Hyogo (JP)

(73) Assignee: USHIO DENKI KABUSHIKI KAISHA, Tokyo (JP)

(21) Appl. No.: 13/408,515

(22) Filed: Feb. 29, 2012

(30) Foreign Application Priority Data
Mar. 1, 2011 (JP) 2011-043768

(51) Int. Cl. H01J 61/30

(52) U.S. Cl. 313/113

(57) ABSTRACT

A light emitting apparatus comprises an excimer lamp and a casing that houses the excimer lamp. A pair of electrodes of the excimer lamp is arranged on an outer surface of a flat electric discharge container whose cross sectional view is rectangular. A light emission section is formed on one face of the discharge container. The casing has a light extraction window that emits radiation light from the light emission section of the excimer lamp to outside of the casing. A reflective film is formed only on an inner wall face of the excimer lamp at a location opposite to the light emission section. The casing has a reflective mirror that reflects the light from the excimer lamp and directs the reflected light toward the light extraction window.

### CROSS-REFERENCES TO RELATED APPLICATION

This application claims priority from Japanese Patent Application Serial No. 2011-043768 filed Mar. 1, 2011, the contents of which are incorporated herein by reference in their entirety.

### TECHNICAL FIELD

The present invention relates to a light emitting apparatus that uses an excimer lamp and, specifically, to a light emitting apparatus suitable for dry washing processing of a template surface in a nanoimprinting apparatus.

### BACKGROUND

In the field of manufacture of a semiconductor chip or a biochip, an optical nanoimprint technology attracts attention in recent years as a method capable of lower cost manufacture, compared with a pattern formation method using photolithography and etching. For example, Japanese Patent Application Publication No. 2000-194142 discloses such a method. In the pattern formation method using the optical nanoimprint technology, a process is performed so that a material layer for a pattern formation is formed on a substrate, such as a wafer, by applying photo-curable resin in form of liquid; a template, on which a pattern used as a negative of a pattern to be formed, is formed in advance, and brought into contact with the material layer for pattern formation; the material layer for pattern formation is irradiated with ultraviolet rays to cure it; and then, the template is removed from the obtained cured resin layer.

In such a pattern formation method, a defect arises in the obtained pattern when a foreign substance or the like exists in a pattern formation face of the template. Thus, it is necessary to perform a washing (cleaning) treatment of the pattern formation face of the template. As shown in Japanese Patent Application Publication No. H8-236492, a wet washing (cleaning) method that uses a solvent, an alkali, acid chemical, or the like is known as a washing method of this template. However, in such a wet washing method, part of the template dissolves with the organic solvent, chemical, or the like, so that there is a possibility that the pattern shape may change. In addition, collection of the washing liquid is also needed, which adds a level of complication to the process. Moreover, when the template is removed from the curable resin layer, remnants of the optical curable resin may adhere to the template. Therefore, since it is necessary to perform a wet washing treatment of the template every time the pattern formation process is completed and since it takes considerable long time to perform this wet washing treatment, there is a problem that productivity decreases remarkably.

Thus, the described relates to a configuration capable of performing dry washing of a template by using a light emitting apparatus equipped with an excimer lamp when a pattern formation face of the template in a nanoimprinting apparatus is washed, so that such a washing treatment is performed efficiently in a short period of time. Further, the describes relates to a configuration of a light emitting apparatus capable of performing dry washing by irradiating the template with ultraviolet rays from a lower side of the template, which has a pattern formation face on its lower side, thereby uniformizing the illuminance distribution on the template as much as possible.

### SUMMARY

The present invention relates to a light emitting apparatus that includes an excimer lamp and a casing that houses the excimer lamp. The casing comprises a light extraction window and a reflection mirror. The excimer lamp comprises a discharge container. The discharge container comprises a light emission section and a reflective film. The reflective film is formed on a first wall of the discharge container. A light emitted from the light emission section or reflected by the reflective film is further emitted through a second wall of the excimer lamp. The light from the excimer lamp is emitted toward the light extraction window, or is reflected by the reflective mirror and is emitted toward the light extraction window.

A pair of electrodes is arranged on an outer surface of the flat electric discharge container whose cross sectional view may be rectangular. A light emission section is formed on one face of the electric discharge container, while a reflective film may be formed on an inner wall face of the excimer lamp at a location opposite to the light emission section. A casing that houses the excimer lamp includes a light extraction window that emits radiation light from the light emission section of the excimer lamp to outside of the casing. The casing has a reflective mirror, which reflects and directs the light transmitted from the a side wall of the excimer lamp toward the light extraction window.

In the light emitting apparatus, since the reflective mirror for reflecting light toward the light extraction window of the casing, is provided, the illuminance of light on an irradiated object, especially the illuminance in a lamp width direction, is made uniform, and also light with increased illuminance is irradiated.

### BRIEF DESCRIPTION OF THE DRAWINGS

Other features and advantages of the present emitting apparatus for washing light nonimprint template and the method for the same will be apparent from the ensuing description, taken in conjunction with the accompanying drawings, in which:

FIG. 1 is a cross sectional view of alight emitting apparatus according to the present invention;

FIG. 2 is a side cross sectional view of the light emitting apparatus shown in FIG. 1;

FIG. 3 is a cross sectional view of the excimer lamp of the present invention;

FIGS. 4A-B are an explanatory diagram in case where a light emitting apparatus is used for washing of a nanoimprinting template;

and

FIG. 5 is an explanatory diagram of experimental examples.

### DESCRIPTION

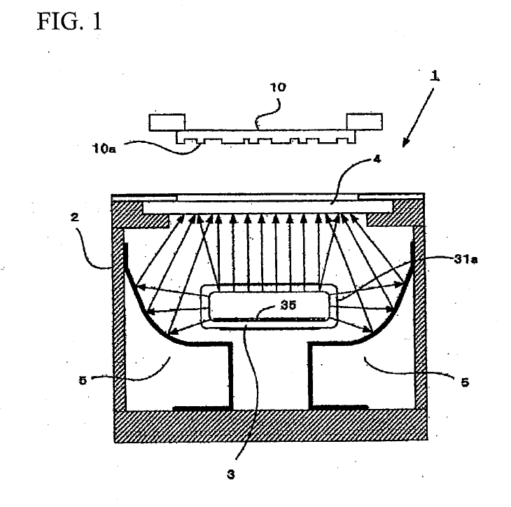

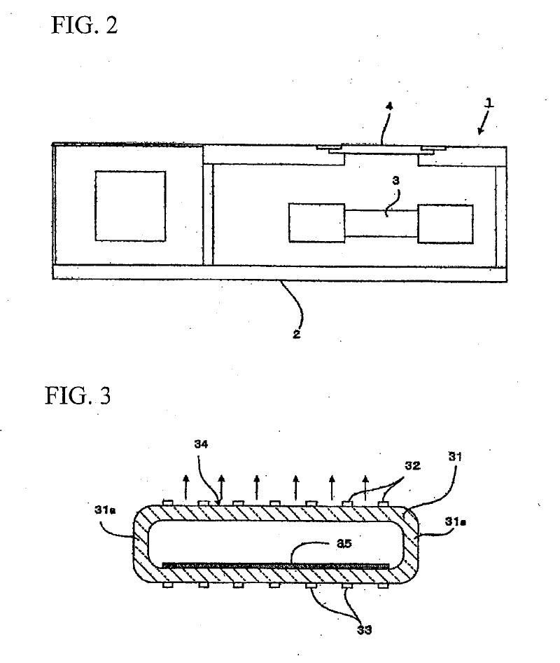

FIG. 1 is a cross sectional view of alight emitting apparatus 1. FIG. 2 is a side cross sectional view. As shown in the figures, the light emitting apparatus 1 comprises a casing 2 and an excimer lamp 3, which is housed inside the casing 2. A light extraction window 4 that emits ultraviolet radiation emitted from the excimer lamp 3 and that, for example, made of quartz glass, is formed in the casing 2. And the inside of the casing 2 is substituted with an inert gas atmosphere. That is, it is filled up with, for example, nitrogen gas. Moreover, as shown in FIG. 3, the excimer lamp 3 of the present invention is made from a transparent member such as quartz glass, and has a flat electric discharge container 31 whose cross sectional view is rectangular, and a pair of electrodes 32 and 33, which are provided on an outer surface of the electric discharge container 31. Discharge gas is enclosed in the electric discharge container 31. The discharge gas is rare gas such as xenon, argon, and krypton, or mixed gas of rare gas and bromine, chlorine, iodine or halogen gas (such as fluorine). And the one face of the electric discharge container 31 functions as a light emission section 34. An ultraviolet-rays reflective film 35 is formed only on one face of an inner wall face, which is located on an opposite side of the light emission section 34. The reflective film 35 is not formed on a face of the inner wall face other than that face. In addition, in an example of the external electrodes 32 and 33, net shape electrodes are shown as the transparent electrodes. However, although such a net shape electrode is used as the electrode 32, which is located on a side of the light emission section 34, the electrode 33 may not necessarily be a net shape electrode, and a non-transparent strip electrode may be used.

As shown in FIG. 1, a reflective mirror 5 is provided in the casing 2. A reflective face of the reflective mirror 5 faces a side wall 31a of the excimer lamp 3, and is arranged to extend in a direction of a tube axis of the excimer lamp 3 along the side wall 31a. The reflective mirror 5 reflects light emitted from the side wall 31a of the excimer lamp 3, toward the light extraction window 4. In addition, the reflective mirror 5 is made of high intensity aluminum or the like.

In FIG. 1, an example, in which the light emitting apparatus 1 is used for washing a template of the nanoimprinting apparatus, is shown. The light emitting apparatus 1 is arranged under the template 10, which has a pattern formation face 10a on its underside. The light extraction window 4 is arranged so as to face the pattern formation face 10a of the template 10. In addition, the template 10 is made of ultraviolet transmitting material, for example, quartz glass.

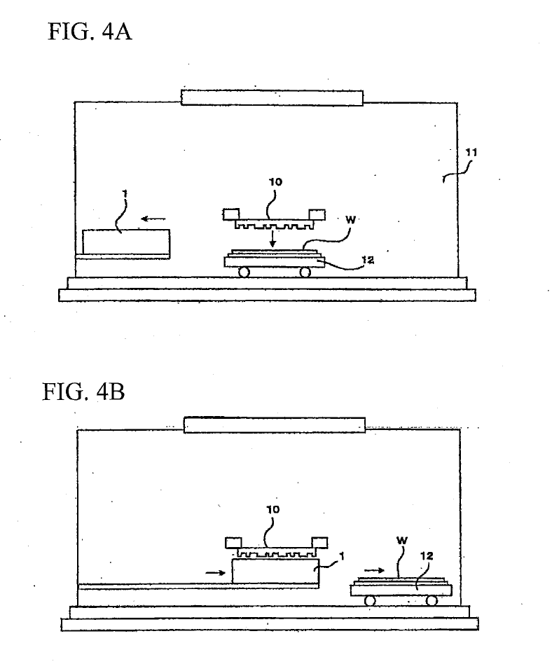

FIGS. 4A-B are an explanatory diagram in case where a light emitting apparatus is used for washing of a nanoimprinting template. In these figures, a support base 12, on which a work piece (substrate) W is placed, is located under the template 10 in a housing 11. The support base 12 is provided to advance and retract with respect to the template 10. FIG. 4A shows a state in which the support base 12 is located at a pattern forming process position directly under the template. At this time, the light emitting apparatus 1 retreats from a position that is directly under the template 10, so as to be in a standby position. In addition, on the upper side of the template 10, an ultraviolet rays light source for curing resist (not shown) is arranged. After the template 10 descends so as to be pressed onto the work piece W on the support base 12, the work piece W is irradiated with ultraviolet rays from the ultraviolet rays light source through the template 10.

FIG. 4B shows a state where after the curing process, the template 10 is stripped off from the substrate W and moved up, so that the pattern formation face 10a of the template 10 is washed or cleaned. In FIG. 4B, the support base 12 is retracted from the space located under the template 10, and the light emitting apparatus 1 is arranged to advance to the space located under the template 10. Remnants such as resist may adhere to concavity and convexity of the pattern formation face 10a of the template 10 by which the curing process is performed once or two or more times. To wash or clean the pattern formation face 10a of the template 10, ultraviolet rays are irradiated thereon from the excimer lamp 3 of the light emitting apparatus 1 through the light extraction window 4, so that the remnants adhering to the pattern formation face 10a of the template 10 are washed and removed.

The specification of the light emitting apparatus 1 according to an embodiment of the present invention is shown below. The casing 2 has the dimension of 100 mm×250 mm×80 mm. The light extraction window 4 is made of quartz glass. The casing has the longitudinal and lateral dimensions of 80 mm×80 mm and the wall thickness is 3 mm. In the excimer lamp 3, xenon gas is enclosed in the electric discharge container 31 made of quartz glass. The light emission length of light emitted is 50 mm, the light emission width is 45 mm, and the output is 15 W.

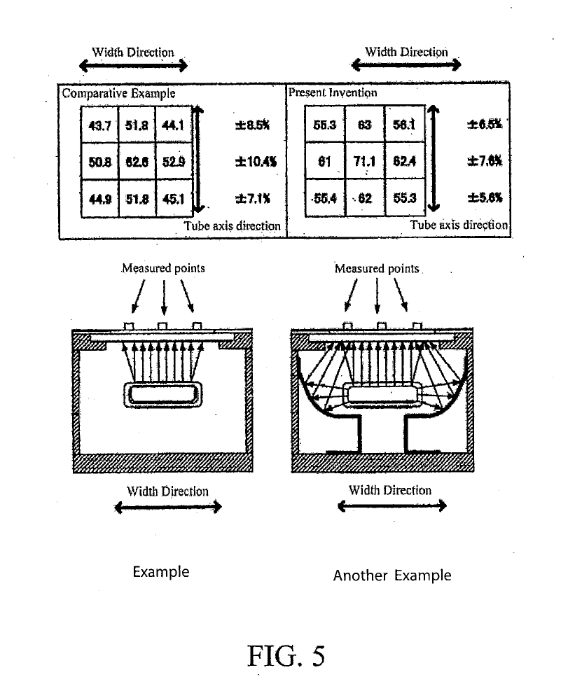

An illuminance measurement experiment was conducted to confirm the effects of the present invention, using the above light emitting apparatus 1. To compare the present invention with a comparative example, a light emitting apparatus was produced as the comparative example. The light emitting apparatus according to the comparative example, has the structure in which a reflective mirror was not provided in a casing. FIG. 5 is an explanatory diagram of experimental examples. In the experiment, an illuminometer was provided to measure illuminance of vacuum-ultraviolet light whose wave length was 172 nm at nine points on an upper face of a light extraction window 4 formed in the casing 2. FIG. 5 shows calculated values of the illuminance uniformity in the width direction of the excimer lamp 3. The illuminance uniformity was calculated by using a formula of {(Max−Min)/(Max+Min)}×100 (%), and expressed in form of ±X.X%, wherein the highest numerical value of illuminance in a width direction is (Max) and the lowest numerical value of illuminance in a width direction is (Min). Consequently, although in the example on the left in FIG. 5, values of the uniformity in the width direction were ±8.5%, ±10.4% and ±7.1%, respectively, values according to another example on the right in FIG. 5 were ±6.5%, ±7.6%, and ±5.6%, respectively. Thus, the illuminance uniformity was improved by providing the reflective mirror. In addition, the entire illuminance was also increased.

As explained above, in the light emitting apparatus, the reflective film was formed only on the inner wall face of the excimer lamp that is on an opposite side to the light emission section. The reflective mirror reflects light, which transmits the side wall of the excimer lamp, toward the light extraction window of the casing. Therefore, while there is the effect that a work piece can be irradiated with the light whose illuminance uniformity in the width direction of the excimer lamp is improved, there is an effect that the entire illuminance is also increased.

The preceding description has been presented only to illustrate and describe exemplary embodiments of e present emitting apparatus for washing light nonimprint template and the method for the same. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A light emitting apparatus comprising:
a casing that houses an excimer lamp;
the casing comprises a light extraction window and a reflection mirror;
the excimer lamp comprises a discharge container, the discharge container comprises a light emission section and a reflective film, the reflective film is formed on a first wall of the discharge container;
a light emitted from the light emission section or reflected by the reflective film is emitted through a second wall of the excimer lamp, the light from the excimer lamp is emitted toward the light extraction window, or is reflected by the reflective mirror and is emitted toward the light extraction window.

2. A light emitting apparatus according to claim 1, the first wall and the second wall are flat.

3. A light emitting apparatus according to claim 2. a cross sectional view of the discharge container is rectangular.

4. An excimer lamp comprising:
a discharge container, the discharge container comprises a light emission section and a reflective film, the reflective film is formed on a first wall of the discharge container;
a light emitted from the light emission section or reflected by the reflective film is emitted through a second wall of the excimer lamp; and
a first electrode that is arranged on an outside of the first wall and a second electrode that is arranged on an outside of the second wall.

5. A light emitting apparatus according to claim 4, the first wall and the second wall are flat.

6. A light emitting apparatus according to claim 5. a cross sectional view of the discharge container is rectangular.

7. A light emitting apparatus comprising:
a casing that houses the excimer lamp according to claim 4;
the casing comprises a light extraction window and a reflection mirror;
the light from the excimer lamp is emitted toward, or is reflected by the reflective mirror and is emitted toward the light extraction window.

8. A light emitting apparatus comprising:
a casing that houses the excimer lamp according to claim 5;
the casing comprises a light extraction window and a reflection mirror;
the light from the excimer lamp is emitted toward, or is reflected by the reflective mirror and is emitted toward the light extraction window.

9. A light emitting apparatus comprising:
a casing that houses the excimer lamp according to claim 6;
the casing comprises a light extraction window and a reflection mirror;
the light from the excimer lamp is emitted toward, or is reflected by the reflective mirror and is emitted toward the light extraction window.
